(19) United States
(12) Patent Application Publication
(10) Pub. No.: US 2021/0350412 A1
(43) Pub. Date: Nov. 11, 2021

(54) Mobile Intelligent Dynamic Advertising System

(71) Applicant: International Business Machines Corporation, Armonk, NY (US)

(72) Inventors: Brandon Harwood, Dallas, TX (US); John Scott Pannell, Tarrant, TX (US); Gregory Scott Jones, Lewisville, TX (US)

(21) Appl. No.: 16/868,911

(22) Filed: May 7, 2020

(51) Int. Cl. G06Q 30/02; G09F 21/04; G09F 19/18

(52) U.S. Cl. CPC G06Q 30/0266; G06Q 30/0246; G09F 19/18; G09F 21/04; G06Q 30/0272

(57) ABSTRACT

An approach mobile intelligent dynamic advertising is disclosed. The approach includes detecting a presence of pedestrians within a predetermined distance of a vehicle and/or live platform and determining, leveraging machine learning, an advertisement to be displayed to the pedestrians based on predetermined displayed criteria. The approach determines an optimal area or surface for displaying the advertisement and can dynamically alter a layout of the advertisement based various factors.

### BACKGROUND

The present invention relates generally to advertising, and more particularly, to vehicle-advertising display systems for mobile advertisement systems.

There are several methods of displaying mobile advertising on vehicles. Some of the methods that are currently in use involve static printed or painted images and text. Other methods involving electronic displays are gaining popularity. Display technologies include display screens (e.g., LCD, LED, etc.) and projections (e.g., LCD, DLP, etc.).

### SUMMARY

Aspects of the present invention disclose a computer-implemented method, and computer system for identifying and predicting usage pattern associated within a MIDAS (mobile intelligent dynamic advertisement system) environment. The computer implemented method includes, detecting a presence of pedestrians within a predetermined distance of a vehicle; determining an advertisement to be displayed to the pedestrians based displayed criteria; determining an optimal area or surface within a predetermined distance of the vehicle for displaying the advertisement; altering a layout of the advertisement based, at least in part, on dimensional attributes of the optimal surface and portions of the optimal surface that are determined to be conducive for displaying the advertisement based on detected obstructions within the optimal surface where the advertisement is to be displayed; and displaying, by the vehicle, the advertisement based on the altered layout.

In another embodiment, the computer system includes one or more computer processors; one or more computer readable storage media; program instructions stored on the one or more computer readable storage media for execution by at least one of the one or more computer processors, the program instructions comprising: program instructions stored on the one or more computer readable storage media for execution by at least one of the one or more computer processors, the program instructions comprising: program instructions to detect a presence of pedestrians within a predetermined distance of a vehicle; program instructions to determine an advertisement to be displayed to the pedestrians based displayed criteria; program instructions to determine an optimal area or surface within a predetermined distance of the vehicle for displaying the advertisement; program instructions to alter a layout of the advertisement based, at least in part, on dimensional attributes of the optimal surface and portions of the optimal surface that are determined to be conducive for displaying the advertisement based on detected obstructions within the optimal surface where the advertisement is to be displayed; and program instructions to display, by the vehicle, the advertisement based on the altered layout.

### BRIEF DESCRIPTION OF THE DRAWINGS

FIG. 1 is a functional block diagram illustrating a topology of a MIDAS environment, designated as 100, in accordance with an embodiment of the present invention;

FIG. 2A is a functional block diagram illustrating Vehicle Mounted Advertising Display on a vehicle in accordance with an embodiment of the present invention;

FIG. 2B is a rear view of a truck with a VMAD in accordance with an embodiment of the present invention;

FIG. 2C is a rear view of a sedan with a VMAD in accordance with an embodiment of the present invention;

FIG. 2D is a functional block diagram illustrating the projection capability of the VMAD on the street, in accordance with an embodiment of the present invention;

FIG. 2E is a functional diagram illustrating multiple VMADs being used on multiple vehicles in a coordinated manner, in accordance with another embodiment of the present invention;

FIG. 3 is a diagram illustrating an alternative use of an advertisement display system by a human platform in accordance with another embodiment of the present invention;

FIG. 4 is a functional block diagram illustrating advertisement component, designated as 400, in accordance with an embodiment of the present invention;

FIG. 5 is a flowchart illustrating the operation of advertisement component 111, designated as 500, in accordance with an embodiment of the present invention; and

FIG. 6 depicts a block diagram, designated as 600, of components of a server computer capable of executing the advertisement component 111 within the MIDAS environment, of FIG. 1, in accordance with an embodiment of the present invention.

### DETAILED DESCRIPTION

Embodiments of the present invention provide an approach for a mobile intelligent dynamic advertisement system (MIDAS), electronic displays mounted on vehicle, that allows for the remote delivery of advertisement content based on the vehicle's current location and other real-time data, as well as a system for paying the vehicle owner for displaying the advertising. A multitude of different display technologies can be used, for example, ads could be: i) projected on the vehicle's windows or onto the ground adjacent to the vehicle or ii) displayed on screens mounted to the vehicle. The owner of the vehicle earns income by “selling” advertisement on their vehicle. Furthermore, business owners with multiple business vehicle use similar setups to advertise solely for their own services and goods. Ad/ads (advertisements) is primarily be displayed while vehicles are parked. However, depending on the mounting location and type of ad display used, it may be safe and practical to display ads on vehicles that are in motion.

In an embodiment, MIDAS can be deployed in a package that can worn by a person and/or animal, instead of being mounted on a vehicle (see FIG. 3). The specific ads displayed can be selected based on similar rules/policies as vehicle mounted displays.

Ad selection criteria can be based on several factors, including, but not limited to one or more of: i) vehicle and/or live platform location, ii) advertisement purchaser location relative to vehicle and/or live platform location, iii) time of day, iv) profile settings of the MIDAS equipped vehicle or live platform, v) billing algorithms and profile settings (if a variable pricing scheme is used), vi) display methods available on the vehicle, and viii) demographic information of passersby or bystanders.

MIDAS may also include a system for paying the vehicle owner for displaying the advertising. There are a multitude of options for determining payment amounts, ranging from simple flat rates to more complex schemes that consider, but are not limited to, one or more of: location, time of day, and passerby interest. Schemes may also be implemented to determine payments on a ‘bidding’ based model, whereby businesses bid for the use of MIDAS units in selected areas.

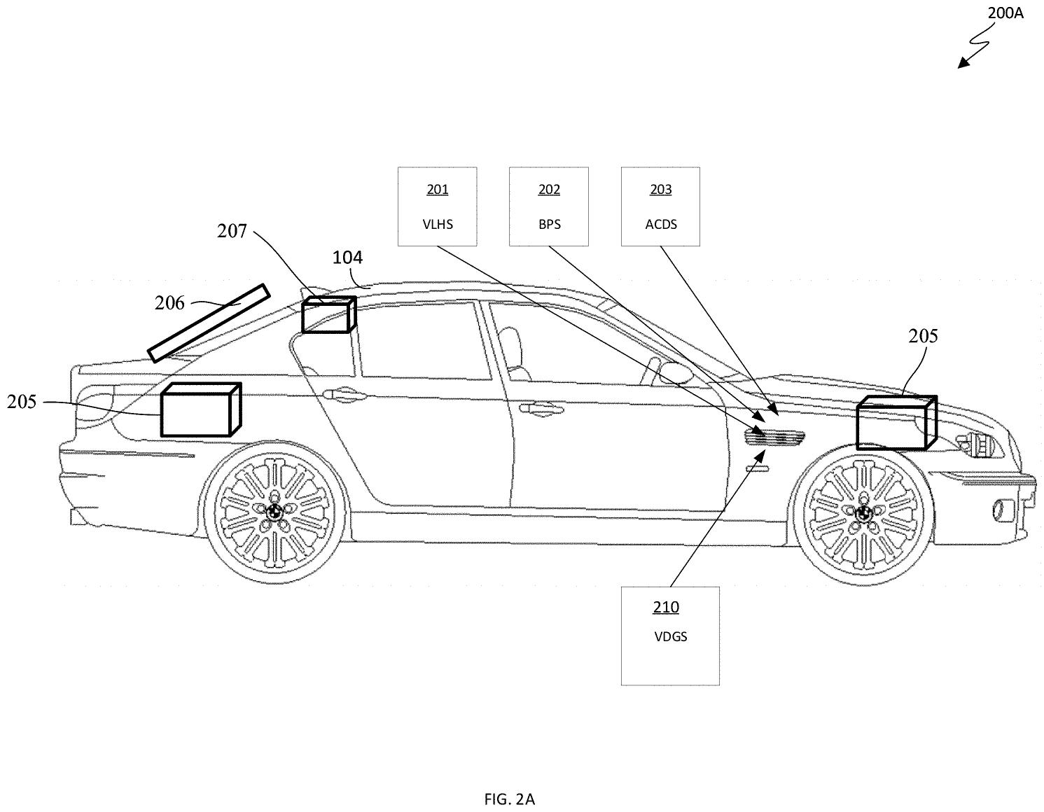

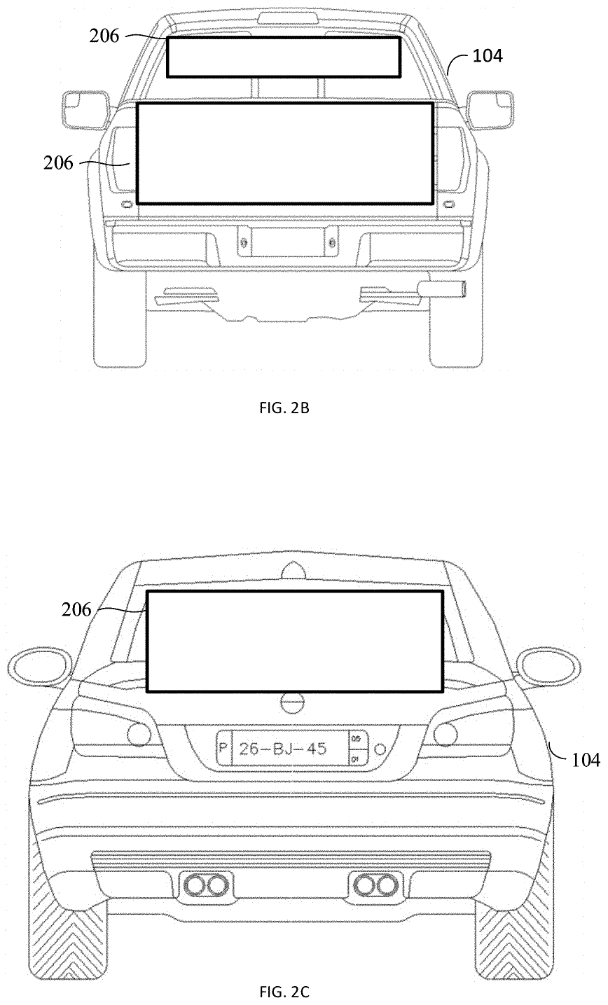

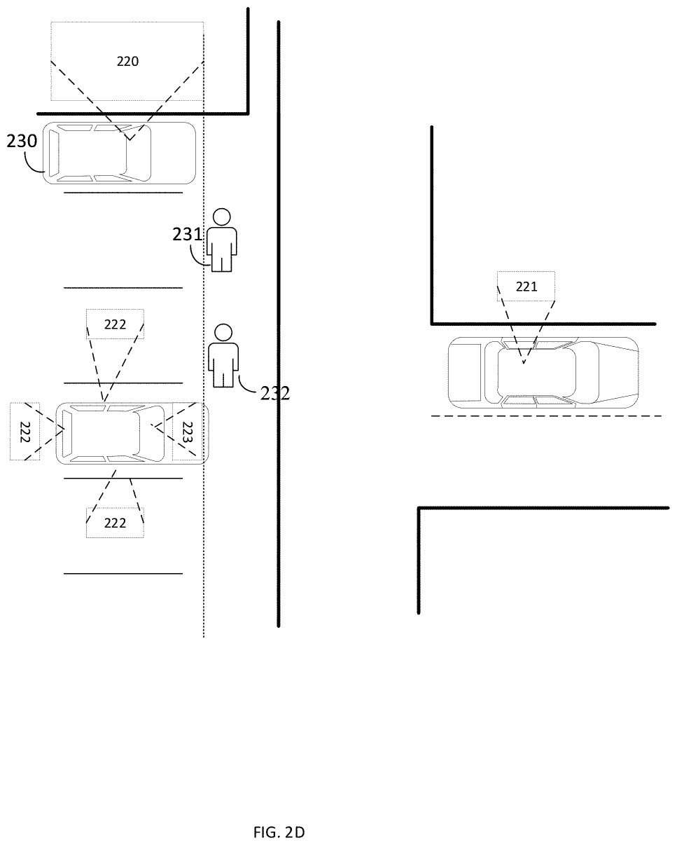

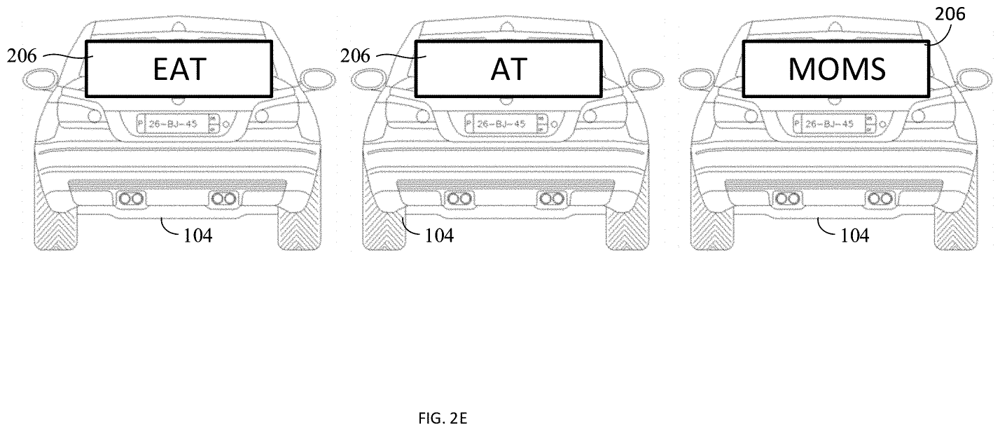

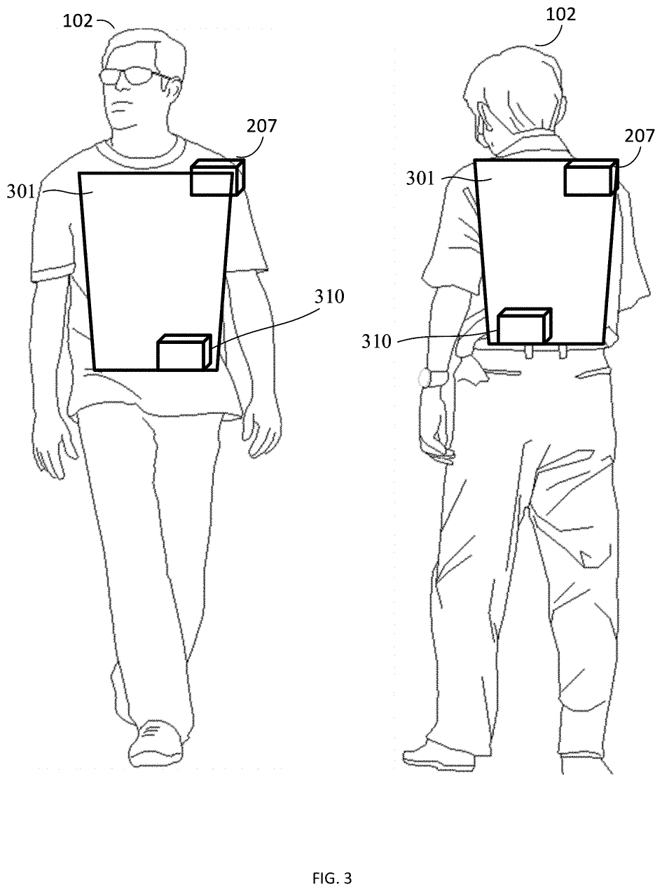

Embodiments of present invention have the following advantages: i) using video analytics to detect interest in passersby and/or bystanders, ii) allowing passersby and/or bystanders to interact with the system to scroll back and forth through multiple ads or request more detail on a specific ad, iii) using ad displays as supplemental brake lights and turn signals on moving vehicles, iv) ability for private vehicle owners to generate revenue via profiled and filtered advertising content that is acceptable to the vehicle owner, v) ability for private vehicle owners to determine when content can be shown and what locations content can be displayed, vi) using multiple adjacent vehicles to display a larger ad (i.e., see FIG. 2E), vii) allowing the system to be used for emergency and/or public service notifications, viii) ability to vary the payment amount to the vehicle owner for external advertisements displayed based on variables such as vehicle location, time of day, distance from the advertised business, and/or number of passerby detected, and ix) ability to target content to collect demographic information through visual analytics of passersby and/or bystanders and alter content based on data collected.

A detailed description of embodiments of the claimed structures and methods are disclosed herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the Figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

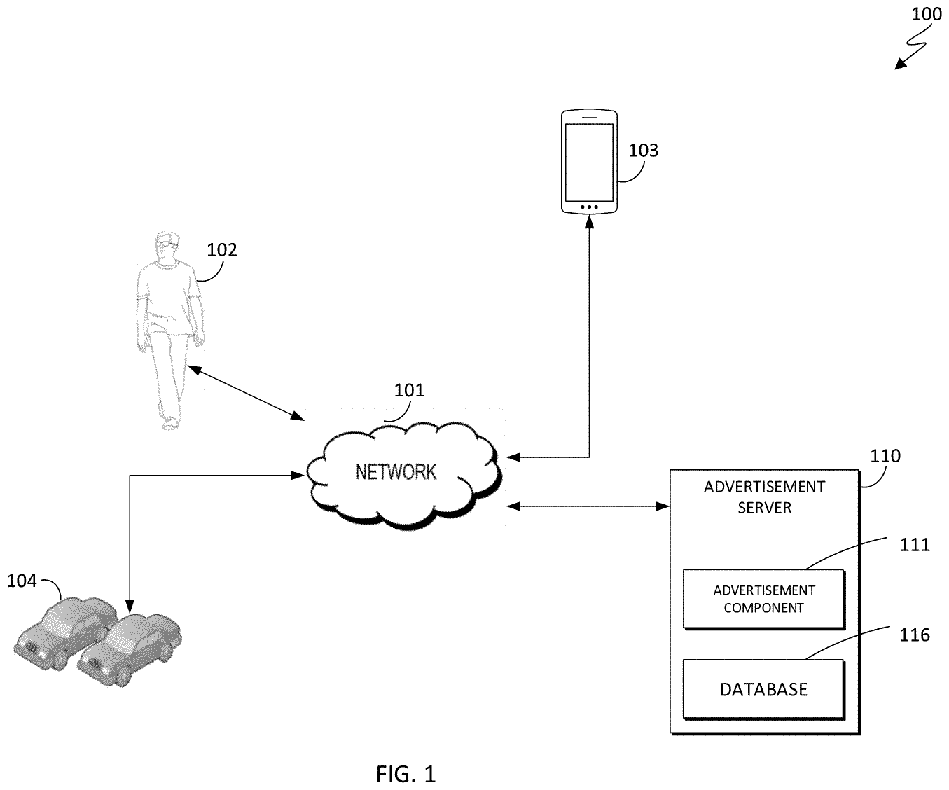

FIG. 1 is a functional block diagram illustrating a topology of a MIDAS environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

MIDAS environment 100 includes network 101, live platform 102, mobile device 103, vehicle platform 104 and advertisement server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between advertisement server 110, live platform 102, mobile device 103, vehicle platform 104 and other computing devices (not shown) within MIDAS environment 100. It is noted that other computing devices can include, but is not limited to, wearable mobile devices and any electromechanical devices capable of carrying out a series of computing instructions.

Live platform 102 are living entities that can be utilized to wear mobile ad displays (see FIG. 3). For example, a human and/or animal, such as a dog.

Mobile device 103 is a network capable mobile computing device that may receive and transmit confidential data over a wireless network between one or more client/customers utilizing the services/application from live platform 102. Mobile device 103 can be a laptop computer, tablet computer, netbook computer, personal computer (PC), a personal digital assistant (PDA), a smart phone, smart watch (with GPS location) or any programmable electronic device capable of communicating with server computers (e.g., advertisement server 110 and/or live platform 102) via network 101, in accordance with an embodiment of the present invention. Mobile device 103 may include removable or built-in projection hardware that can display/project information onto a solid surface. Additionally, mobile device 103 may have holographic and/or 3D capability.

Vehicle platform 104 is one or more vehicles utilized by one or more users. Vehicle platform 104 can be a multi-wheel vehicle (e.g., motorcycle, passenger car, bus, etc.). Vehicle platform 104 can also be a vehicle without any wheels, such as an unmanned aerial vehicle (UAV).

Advertisement server 110 can be a standalone computing device, a management server, a web server, a mobile computing device, or any other electronic device or computing system capable of receiving, sending, and processing data. In other embodiments, advertisement server 110 can represent a server computing system utilizing multiple computers as a server system, such as in a cloud computing environment. In another embodiment, advertisement server 110 can be a laptop computer, a tablet computer, a netbook computer, a personal computer (PC), a desktop computer, a personal digital assistant (PDA), a smart phone, or any other programmable electronic device capable of communicating other computing devices (not shown) within 100 via network 101. In another embodiment, advertisement server 110 represents a computing system utilizing clustered computers and components (e.g., database server computers, application server computers, etc.) that act as a single pool of seamless resources when accessed within MIDAS environment 100.

Advertisement server 110 includes advertisement component 111 and database 116.

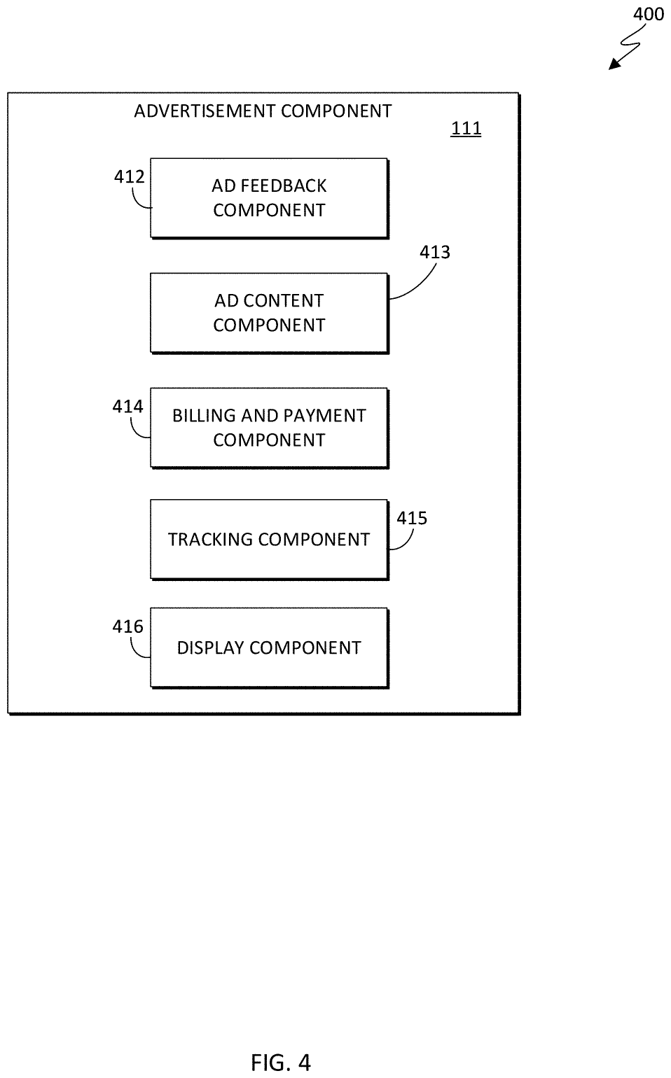

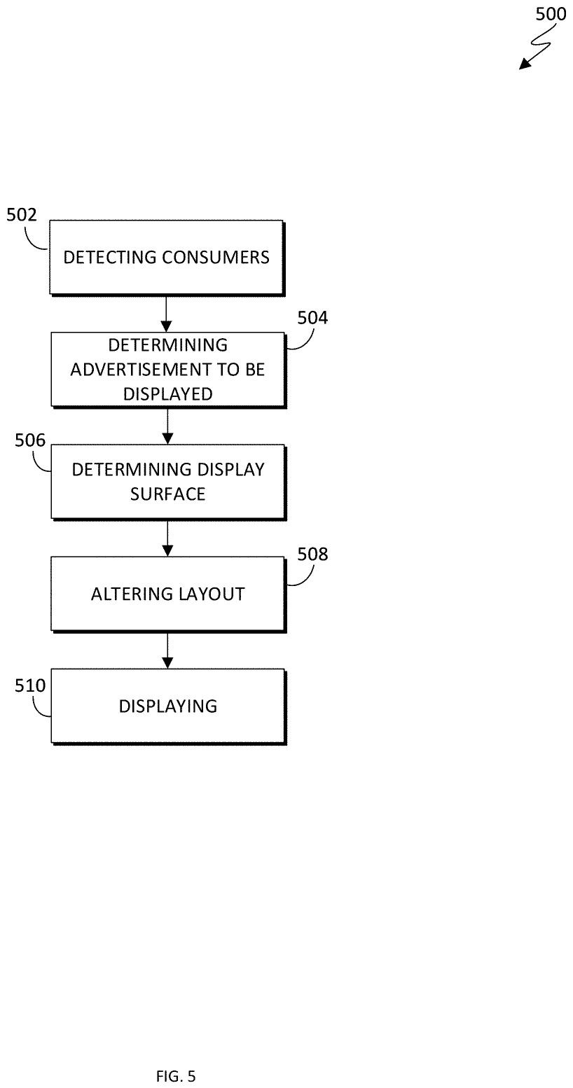

Advertisement component 111 is a software-based component capable of coordinating advertisement activities (e.g., selecting advertisement to be displayed, tracking amount of time displayed including location, managing billing and payment system associated with the advertisements) within MIDAS environment 100. Subcomponents of advertisement component 111 will be discussed in greater details in FIG. 4.

Database 116 is a repository for data used by advertisement component 111. Database 116 can be implemented with any type of storage device capable of storing data and configuration files that can be accessed and utilized by advertisement server 110, such as a database server, a hard disk drive, or a flash memory. Database 116 uses one or more of a plurality of techniques known in the art to store a plurality of information. In the depicted embodiment, database 116 resides on advertisement server 110. In another embodiment, database 116 may reside elsewhere within MIDAS environment 100, provided that advertisement component 111 has access to database 116. Database 116 may store information associated with, but is not limited to, weather forecast, traffic pattern, street map, advertisement rules, profile of the vehicle owner/live platform, advertisement content, display interface protocols, vehicle telemetry data, vehicle profile and financial account (payment purposes).

The MIDAS system, for vehicle platform 104, consists of five major components: i) VMAD (Vehicle Mounted Advertising Displays), ii) VDGS (Vehicle Data Gathering System), iii) ACDS (Ad Content Delivery System), iv) BPS (Billing and Payment System), and v) VLHS (Vehicle Location History System). Note that the Vehicle Location History System, Ad Content Delivery System, and Billing and Payment System are described here as separate systems, however, they could be implemented as different functions of the same physical computing system. Each of these components is discussed in further detail below.

FIG. 2A is a functional block diagram illustrating VMAD (Vehicle Mounted Advertising Display) on a vehicle (i.e., vehicle platform 104), designated as 200A, in accordance with an embodiment of the present invention. 200A includes the following, vehicle platform 104, VLHS 201, BPS 202, ACDS 203, projector 205, vehicle display 206, sensors 207, VDGS 210.

VLHS (Vehicle Location History System) 201 is a software-based system (with a hardware interface to a vehicle) for tracking vehicle location and/or vehicle movements. VLHS 201 will be described in greater detail as it relates to tracking component 415 in FIG. 4.

BPS (Billing and Payment System) 202 is a software-based system used to calculate and manage billing and payment. Managing billing and payment by BPS 202 will be described in greater detail as it relates to billing and payment component 414 in FIG. 4.

ACDS (Ad Content Delivery System) 203 is a software-based backend system which can determine which MIDAS equipped vehicles is selected to display ads and determine which ad(s) are to be displayed by each vehicle. Selection of advertisements by ACDS 203 will be described in greater detail as it relates to ad content component 413 in FIG. 4.

VMAD devices can display still or moving text, images, and video advertising content using any of several existing technologies (e.g., LCD, LED, projection, hologram, etc.). VMAD devices, such as, projector 205 can display advertisement content on the inside/outside of vehicle windows using vehicle displays 206 and project ads on the ground adjacent to the vehicle (see FIG. 2D for examples of projected ads) via projector 205. VMAD devices such as vehicle display 206 can display content on screens mounted on the rear window of a vehicle (see FIGS. 2B and 2C) or to any exterior surfaces not obstructed by parts of the vehicle. Although it is generally assumed that many of the possible display methods would not be used while the vehicle is in motion, for reasons of safety and lack of effectiveness ads can be displayed while the vehicle is in motion if it has been deemed safe/suitable/legal by appropriate legislation. VMAD devices can enhance vehicle safety by interfacing with a vehicle's electrical/telemetry system to use a rear-facing display (i.e., vehicle display 206) to show notifications to following drivers when the brakes are applied or when turn signals are activated.

Sensors 207 are various sensors (e.g., speed, rotation, steering angle, lateral acceleration, vertical axis, etc.) that can measure the vehicle dynamics. Sensors 207 can include other non-vehicle related sensors (e.g., camera, video, microphone, and proximity/motion detection). Proximity/motion sensors can detect the presence of a passerby when the vehicle is not in motion or video or still cameras to detect the presence of passerby when the vehicle is not in motion. This would allow the use of video analytics to identify demographic characteristics of the passerby to allow for better targeting of the displayed ads. Cameras can also be utilized to measure passerby's cognitive state (e.g., interested, happy, sad, sleepy, angry, and tired) as the passerby views the advertisements. It is noted that sensors 207 can be deployed on any vehicle and on live platform 102. Sensors can use various forms of communication technology to send and receive data between vehicle platform 104, live platform 102, mobile device, 103 or advertisement server 110 such as wi-fi, Bluetooth, cellular internet, or satellite internet connectivity or any other short, medium or long-range wireless data exchange technology.

VDGS (Vehicle Data Gathering System) 210 is a conglomeration of components in the vehicle designed to gather information associated with vehicle movement, detection of passersby, and interface to ACDS 203. VDGS 210 includes subcomponents, such as i) GPS receiver/tracking, ii) vehicle telemetry interface (e.g., OBDII, CANBUS, VAN, MOST, etc.) to vehicle status (e.g., parked, in motion, etc.), iii) interface to various external/internal sensors on the vehicle (i.e., sensors 207), and iv) interface to ACDS 203.

In another embodiment VDGS 210 can perform similar functions (e.g., tracking, etc.) as in a vehicle but for live platforms 102, wherein VDGS 210 can be embedded in WAD 301 or as a separate unit bundled inside WAD control unit 310 (see FIG. 3). For example, WAD control unit 310 can perform tracking of live platform 102 and interface with sensors 207.

FIG. 2B is a rear view of a truck with a VMAD installed on the rear windshield in accordance with an embodiment of the present invention. Similarly, FIG. 2C is a rear view of a sedan with a VMAD installed on the rear windshield.

FIG. 2D is a functional block diagram illustrating the projection capability of the VMAD on the street, in accordance with an embodiment of the present invention. Advertisements can be projected from vehicle platform 104, through projector 205, onto the street surface, side of buildings or generally, any non-transparent surfaces. For example, vehicles can project advertisements onto, but not limited to, one or more of: i) sidewalks 221, ii) parking lot/street surfaces 222, iii) on top of vehicle surfaces 223 (e.g., hood, trunk, etc.), and iv) side of buildings 220. It is noted that if projector 205 is equipped with holographic and/or 3D (three-dimensional) capability then no surfaces are required for the display of advertisements.

FIG. 2E is a functional diagram illustrating multiple VMADs being used on multiple vehicles in a coordinated manner, in accordance with another embodiment of the present invention. For example, three vehicles in a parking lot with their vehicle display 206 facing in the same direction can display coordinated and/or synchronized advertisements across the three vehicle displays 206.

Similarly, multiple displays (i.e., 301 of FIG. 3) carried by live platforms can be utilized in a manner similar to the three vehicles adjacent to each other assuming the live platforms are within visual proximity of each other. Other embodiments can include a mix of live platforms 102 and vehicle platform 104 in a coordinated manner. For example, three vehicles can be parked next to each other in a parking lot along with multiple WADs (worn by live platforms) wherein the same advertisement is coordinated utilizing all available displays.

FIG. 3 is a diagram illustrating an alternative use of an advertisement display system by a human platform in accordance with another embodiment of the present invention. Live platform 102 can be used instead of vehicles to display advertisements. In the current embodiment, WAD (wearable advertisement display) 301 contains the display with embedded, sensors 207 and WAD control unit 310. WAD 301 are devices that can display images (e.g., text, videos, etc.). WAD 301 can be made from LCD, OLED, LED, or any existing display technology. For example, WAD 301 can be worn by a human as noted in FIG. 3 or even an animal, such as a dog. WAD 301 can be a self-contained system that houses a non-vehicle version of ACDS 203, BPS 202, VDGS 210 and VLHS 201. In an embodiment, WAD control unit 310 can mimic the functionality of ACDS 203, BPS 202, VDGS 210 and VLHS 201. For example, WAD control unit 310 can perform tracking of live platform 102 and interface with sensors 207.

It is noted that WAD 301 can remotely display advertisements from ACDS 203 that is on a vehicle platform 104. Furthermore, WAD 301 can be synchronized to advertisements being displayed on vehicle platform 104. For example, multiple WAD 301 can be utilized by live platform 102 (lined up together similar to FIG. 2E) and can be used to display coordinated/synchronized advertisements across multiple WAD 301.

FIG. 4 is a functional block diagram illustrating advertisement component 111 in accordance with an embodiment of the present invention. In the depicted embodiment, advertisement component 111 includes ad feedback component 412, ad content component 413, billing and payment component 414, tracking component 415 and display component 416.

As is further described herein below, ad feedback component 412 of the present invention provides the capability of gauging the feedback of the consumer. Ad feedback component 412 can gauge the feedback of consumers by detecting and ascertaining reactions (e.g., facial expression/reaction, body movement, etc.) while viewing the advertisements. Ad feedback component 412 is capable of communicating (e.g., sending, receiving) between various advertisement feedback sensors within MIDAS environment 100. For example, vehicle platform 104 is equipped with advertisement feedback sensors (i.e., sensors 207), such as a camera, that can detect facial expression of passersby as they view advertisements on vehicle display 206. If ad feedback component 412 determines that the user is not interested in the current displayed advertisement, it can request ad content component 413 (i.e., ACDS 203) for other advertisement content to be displayed.

In an embodiment, ad feedback component 412 along with ad content component 413, can allow passersby to interact with the VMAD (e.g., through sensors 207 and/or mobile device belonging to passersby) to scroll through multiple ads, pause at a specific ad, or to indicate a desire to see more information on a specific advertisement. Is it noted the interaction described above can be utilized by live platform 102 as well.

As is further described herein below, ad content component 413 of the present invention provides the capability of selecting advertisements (leveraging artificial intelligence) to be displayed. A display criterion can be used by ad content component 413 to select appropriate advertisements for the potential passersby/consumers/pedestrians. Display criterion can be based on several factors, including, but not limited to one or more of: i) vehicle and/or live platform location, ii) advertisement purchaser location relative to vehicle and/or live platform location, iii) time of day, iv) profile settings of the MIDAS equipped vehicle, v) billing algorithms and profile settings (if a variable pricing scheme is used), vi) display methods available on the vehicle (not related to live platforms), viii) demographic information on passersby within a predetermined distance of the vehicle/live platform (i.e., detected by sensors 207), ix) information obtained from mobile devices and social media accounts associated with the pedestrians (assuming this information is publicly available and not restricted by any privacy settings) and, x) business information of those businesses located within a predetermined distance of the vehicle/live platform. Regarding criteria iv), “profile settings of the MIDAS equipped vehicle,” means that certain profile settings on the by the MIDAS-equipped (similarly, setting of live platforms) may not want to advertise certain types of advertisement. For example, some owners of the MIDAS vehicle may prefer to advertise during certain hours (i.e., Monday to Friday only and at 6 AM to 6 PM). In another example, vehicle owners could opt out of displaying ads for certain businesses or types of businesses based on profile settings. Thus, the profile can also allow the vehicle owner to define locations in which the system should not display any ads, such as while at home or at the workplace. It is noted, ad content component 413, can interface to MIDAS equipped vehicle and perform functions associated with ACDS 203 and VDGS 210 (see FIG. 2A).

In an embodiment, by leveraging artificial intelligence through sensors 207, ad feedback component 412 can display advertisements that may interest the passersby as they are approaching vehicle display 206. For example, a jogger, wearing a typical jogging attire, is detected by sensors and ad feedback component 412. Ad feedback component 412 has determined that the passerby is jogging and queries ad content component 413 for athletic-related advertisements such as athletic clothes or sporting event tickets. In another example, a football fan, wearing a professional football jersey of a famous quarterback is walking down the street and ad feedback component 412 determines that the passerby may be interested in football related advertisements and retrieves the advertisements from ad content component 413.

In another embodiment, ad content component 413 can manage a repository of advertisement files. Advertisement files can be stored in a database (i.e., database 116) or can be live-streamed from a remote advertisement file server.

As is further described herein below, billing and payment component 414, of the present invention provides the capability of facilitating tracking an amount of time advertisements are displayed/shown, billing the owner of the advertisement, and receiving payment from the owner of the advertisement. It is noted, billing and payment component 414, can interface to MIDAS equipped vehicle and coordinate functions associated with BPS 202 (see FIG. 2A).

Billing and payment component 414 can track and record the amount of time and time of day that each MIDAS vehicle (or live platform 102) spent displaying each ad, the display method used, and any other data relevant to billing for the display of the ad.

Billing can be as simple as a flat fixed rate based on the duration of the display of a given ad or could involve more complex calculations that take into consideration the vehicle location, time of day, distance from the advertised business, and/or number of passersby detected. It is noted that blockchain technology can be used to track the length of time and/or frequency an advertisement is displayed, track the number of pedestrians/consumers viewing an advertisement, and track billing of the owner of the advertisement and payments received for displaying an advertisement. A billing scheme can also be developed based on bidding, where vehicle owners can set an opening bid and minimum charge for displaying an ad, and businesses would set an opening bid and maximum charge. Computer based algorithms may then automatically negotiate a rate acceptable to both parties. If the billing rate is also affected by vehicle location or other factors, then more complex algorithms can be used to determine the optimum vehicles to use to display a specific ad based on location and negotiated price.

The system can also handle making payments to the owners of MIDAS equipped vehicles and/or to live platform 102 owners. This may be via electronic funds transfer or generation of a hardcopy check, either on a periodic basis. Use of electronic funds transfers would allow the potential for owners of MIDAS equipped vehicles to be paid on a more frequent basis, even daily.

As is further described herein below, tracking component 415 provides the capability of recording the location of live platform 102 and vehicle platform 104. Tracking component 415 can coordinate with VLHS 201 to record the location of all MIDAS equipped vehicles, at all times when the vehicle's MIDAS system is enabled. It can then make this information available to ad content component 413 and billing and payment component 414. Similarly, tracking component 415 can track live platform 102. For example, VLHS 201, vehicles using MIDAS can be equipped with, but is not limited to, one or more of: a GPS receiver to determine vehicle position (i.e., vehicle GPS 211), and ii) interface (via OBDII 213) to the vehicle to determine whether the vehicle is in use but not moving, in motion, or parked (it is noted that interface to the vehicle can be over OBDII (On-Board diagnostic, Updated), CAN-BUS (Controller Area Network bus) or any current technologies within the automotive industry for communication).

As is further described herein below, display component 416 provides the capability of interfacing between ACDS 203 with various display devices. Display devices (e.g., LCD screen, projectors, etc.) may use different protocols (e.g., PAL, NTSC, etc.) to display visual images. Display component 416 is capable of translating various advertisement file formats (from ACDS 203) through appropriate codecs into a format suitable for are particular display(s). For example, advertisement component 111 receives an instruction to display an advertisement associated with sports and ad content component 413 retrieves the specified advertisement file(s) from storage (e.g., database 116). Display component 416 renders and transmits to a display device (e.g., live platform 102, vehicle platform 104, mobile device 103). Using vehicle platform as an example, ad content component 413 can instruct ACDS 203, through display component 416, to display ad content by projector 205 and vehicle display 206.

In an embodiment, display component 416 can also use multiple vehicles that are parked adjacently to each display a portion of a larger ad image (see FIG. 2E as an example). Similarly, display component 416 can coordinate a single advertisement across multiple live platforms 102.

In embodiment, display component 416 can interface with local emergency warning systems so that MIDAS equipped vehicles can be commandeered by authorities to display emergency warnings such as severe weather alerts, Amber and Silver alerts, and notification of nearby emergency situations. Display of these warnings may take precedence over display of any paid advertising.

FIG. 5 is a flowchart illustrating an operation of MIDAS environment 100, designated as 500, in accordance with an embodiment of the present invention.

Advertisement component 111 detects consumers (step 502). In an embodiment, advertisement component 111, through ad feedback component 412 (i.e., sensors 207), detects passersby (i.e., potential consumers of advertisement) from vehicle platform 104 (or live platform 102). Ad feedback component 412 determines whether the distance of the passerby to the display (on vehicle or live platform) meets a predetermined minimum advertisement viewing distance threshold (e.g., 10 feet, 8 feet). The AVDT (advertisement viewing distance threshold) can be user-selectable or can be dynamically adjusted by machine learning of advertisement component 111. A use case (case_one) will be used to illustrate the operation of MIDAS environment 100. A MIDAS equipped vehicle, parkedcar_one 230, is parked in parking lot adjacent to a restaurant (see FIG. 2D). parkedcar_one 230 detects pedestrian_one 231 and pedestrian_two 232 on the sidewalk approaching parkedcar_one 230. Pedestrian_one 231 is 9 feet away from parkedcar_one 230 while pedestrian_two 232 is 20 feet away. The current value for AVDT set is 10 feet. Thus, ad feedback component 412 determines that pedestrian_one 231 has met the AVDT and begins to target the pedestrian_one 231. It is noted that pedestrian_two 232 may eventually (assuming that they are both walking towards the same direction) move within AVDT. It is noted that a live platform 102 can be substituted for parkedcar_one 230 in the above use case.

Advertisement component 111 determines an advertisement (step 504). In an embodiment, advertisement component 111, through ad feedback component 412 and ad content component 413, ascertains a type of advertisement for the passerby that has met the threshold. Once the AVDT has been met by a passerby, ad feedback component 412 may use object recognition (via sensors 207) to determine a demographic “profile” of the target. Additionally, ad feedback component 412 may use facial recognition to query for any existing social media or online profile belonging to the passerby to ascertain a possible interest, hobbies associated with available advertisement content. For example, continuing with case_one, pedestrian_one 231 is wearing athletic apparel and is affiliated with a local football team. Ad feedback component 412, based on image recognition and social media profile, determines that pedestrian_one 231 is an avid football fan and enjoys outdoor activities. Thus, ad feedback component 412 queries ad content component 413 for advertisements related to the local football team and other relevant advertisements associated with outdoor adventures. It is noted that an advertisement can be optimized and displayed on multiple surfaces. Traditionally, advertisement spans a single screen/display. However, embodiments of the present invention provide for flexibility to have an advertisement created (by advertisers/production studios) and shown over multiple surfaces, including 3D holograms.

Advertisement component 111 determines a display surface (step 506). In an embodiment, advertisement component 111, through display component 416, determines an optimal output to display an advertisement. Using case_one, parkedcar_one 230 is equipped with vehicle display 206 and projector 205. Ad feedback component 412 determines, based on the path of pedestrian_one 231 and location of vehicle display 206 (i.e., rear windshield) relative to how parkedcar_one 230 is parked to pedestrian_one 231 (i.e., front of car facing passerby), that it is optimal to use projector 205 to display an advertisement against the side of the building (220 of FIG. 2D) where it can be viewed. If the vehicle were parked with the rear facing a passerby, then vehicle display 206 and/or projector 205 could be used either concurrently or sequentially to display advertisement.

Advertisement component 111 alters layout (step 508). In an embodiment, advertisement component 111, through display component 416, alters the layout of a selected advertisement displayed based on the inability to utilize vehicle display 206. For example, using case_one, the local football team advertisement was created to utilize multiple displays. However, since vehicle display 206 is not available, ad feedback component 412 and display component 416 can alter the content of the selected advertisement to fit the available display surfaces (i.e., projector 205).

Advertisement component 111 displays an advertisement (step 510). In an embodiment, advertisement component 111, through display component 416, uses projector 205 to display the selected advertisement on the side of a building.

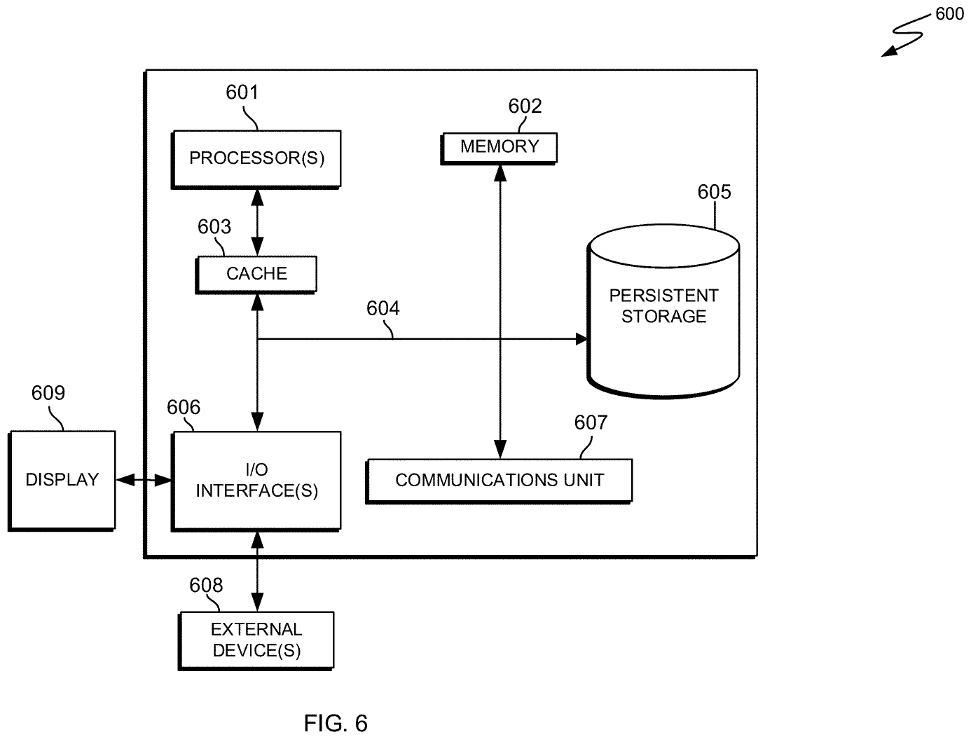

FIG. 6 depicts a block diagram, designated as 600, of components of a server computer capable of executing the advertisement component 111 within the MIDAS environment, of FIG. 1, in accordance with an embodiment of the present invention. FIG. 6 includes processor(s) 601, cache 603, memory 602, persistent storage 605, communications unit 607, input/output (I/O) interface(s) 606, and communications fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processor(s) 601 by holding recently accessed data, and data near recently accessed data, from memory 602.

Program instructions and data (e.g., software and data) used to practice embodiments of the present invention may be stored in persistent storage 605 and in memory 602 for execution by one or more of the respective processor(s) 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605. Advertisement component 111 can be stored in persistent storage 605 for access and/or execution by one or more of the respective processor(s) 601 via cache 603.

Communications unit 607, in these examples, provides for communications with other data processing systems or devices. In these examples, communications unit 607 includes one or more network interface cards. Communications unit 607 may provide communications through the use of either or both physical and wireless communications links. Program instructions and data (e.g., advertisement component 111) used to practice embodiments of the present invention may be downloaded to persistent storage 605 through communications unit 607.

I/O interface(s) 606 allows for input and output of data with other devices that may be connected to each computer system. For example, I/O interface(s) 606 may provide a connection to external device(s) 608, such as a keyboard, a keypad, a touch screen, and/or some other suitable input device. External device(s) 608 can also include portable computer readable storage media, such as, for example, thumb drives, portable optical or magnetic disks, and memory cards. Program instructions and data (e.g., advertisement component 111) used to practice embodiments of the present invention can be stored on such portable computer readable storage media and can be loaded onto persistent storage 605 via I/O interface(s) 606. I/O interface(s) 606 also connect to display 609.

Display 609 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for mobile intelligent dynamic advertising, the computer-implemented comprising:
detecting a presence of pedestrians within a predetermined distance of a vehicle;
determining an advertisement to be displayed to the pedestrians based on a displayed criteria;
determining an optimal area or surface within a predetermined distance of the vehicle for displaying the advertisement;
altering a layout of the advertisement based, at least in part, on dimensional attributes of the optimal surface and portions of the optimal surface that are determined to be conducive for displaying the advertisement based on detected obstructions within the optimal surface where the advertisement is to be displayed; and
displaying, by the vehicle, the advertisement based on the altered layout.

2. The computer-implemented method according to claim 1, wherein the optimal surface includes, but is not limited to, a portion of a sidewalk or road surface adjacent to the vehicle, portion of a wall or building adjacent to the vehicle, and a portion of the vehicle itself.

3. The computer-implemented method according to claim 1, further comprising:
altering the display of the advertisement based on the pedestrian's interaction with the advertisement feedback sensors.

4. The computer-implemented method according to claim 3, wherein the advertisement feedback sensors, further comprises, but is not limited to, camera, video, microphone, and proximity/motion detection.

5. The computer-implemented method according to claim 1, further comprising:
determining that a predefined arrangement of a plurality of vehicles is conducive for displaying a single advertisement and/or group of related advertisements via the plurality of vehicles;
determining, based on the predefined arrangement of the plurality of vehicles, a layout of a single advertisement and/or group of related advertisements to be displayed by the plurality of vehicles;
coordinating a collective and simultaneous display of the single advertisement and/or group of related advertisements via the plurality of vehicles; and
displaying respective portions of the single advertisement and/or group of related advertisements between each of the plurality of vehicles.

6. The computer-implemented method according to claim 5, further comprising:
determining that the predefined arrangement of the plurality of vehicles is no longer conducive for displaying the single advertisement and/or group of advertisements; and
terminating the simultaneous display of the single advertisement and/or group of related advertisements via the plurality of vehicles.

7. The computer-implemented method according to claim 5, further comprising:
determining that an arrangement of a first vehicle with respect to the plurality of vehicles is no longer conducive for displaying the single advertisement and/or group of related advertisements;
altering the layout of the advertisement with respect to the other vehicles in the plurality of vehicles whose arrangement with respect to each other remains conducive for collectively and simultaneously displaying different respective portions of the single advertisement and/or group of related advertisements between the other vehicles in the plurality of vehicles; and
displaying the different respective portions of the single advertisement and/or group of related advertisements between each of the other vehicles in the plurality of vehicles.

8. The computer-implemented method according to claim 1, further comprising:
tracking and recording, via blockchain, an amount of time a vehicle displays particular advertisements and an amount of pedestrians within the predetermined distance of the advertisement.

9. The computer-implemented method according to claim 1, wherein the display criteria is based, at least in part, on one or more of: real-time analytics information, including, but not limited, to a location of the vehicle, demographic information of the pedestrians within the predetermined distance of the vehicle, information obtained from mobile devices and social media accounts associated with the pedestrians, and business information of those businesses located within a predetermined distance of the vehicle.

10. The computer-implemented method according to claim 1, wherein displaying the single advertisement and/or the group of related advertisements is based on one or more display methods, wherein the one or more display methods comprises two-dimensional image or video, three-dimensional image or video, and holographic image or video.

11. A computer system for mobile intelligent dynamic advertising, the system comprising:
one or more computer processors;
one or more computer readable storage media; and
program instructions stored on the one or more computer readable storage media for execution by at least one of the one or more computer processors, the program instructions comprising:
program instructions to detect a presence of pedestrians within a predetermined distance of a vehicle;
program instructions to determine an advertisement to be displayed to the pedestrians based on a displayed criteria;
program instructions to determine an optimal area or surface within a predetermined distance of the vehicle for displaying the advertisement;
program instructions to alter a layout of the advertisement based, at least in part, on dimensional attributes of the optimal surface and portions of the optimal surface that are determined to be conducive for displaying the advertisement based on detected obstructions within the optimal surface where the advertisement is to be displayed; and
program instructions to display, by the vehicle, the advertisement based on the altered layout.

12. The computer system according to claim 11, wherein the optimal surface includes but is not limited to, a portion of a sidewalk or road surface adjacent to the vehicle, portion of a wall or building adjacent to the vehicle and portion of the vehicle itself.

13. The computer system according to claim 11, further comprising:
program instructions to alter the display of the advertisement based on the pedestrian's interaction with the advertisement via an advertisement feedback sensor.

14. The computer system according to claim 13, wherein the advertisement feedback sensors, further comprises, but is not limited to, camera, video, microphone, and proximity/motion detection.

15. The computer system according to claim 11, further comprising:
program instructions to determine that a predefined arrangement of a plurality of vehicles is conducive for displaying a single advertisement and/or group of related advertisements via the plurality of vehicles;
program instructions to determine, based on the predefined arrangement of multiple vehicles, a layout of the single advertisement and/or group of related advertisements to be displayed by the plurality of vehicles; and
program instructions to coordinate a collective and simultaneous display of the single advertisement and/or group of related advertisements via the plurality of vehicles.

16. The computer system according to claim 15, further comprising:
program instructions to determine that the predefined arrangement of the plurality of vehicles is no longer conducive for displaying the single advertisement and/or group of advertisements; and
program instructions to terminate the simultaneous display of the single advertisement and/or group of related advertisements via the plurality of vehicles.

17. The computer system according to claim 15, further comprising:
program instructions to determine that an arrangement of a first vehicle with respect to the plurality of vehicles is no longer conducive for displaying the single advertisement and/or group of related advertisements; and
program instructions to alter the layout of the advertisement with respective to the other vehicles in the plurality of vehicles whose arrangement with respect to each other remains conducive for collectively and simultaneously displaying the single advertisement and/or group of related advertisements.

18. The computer system according to claim 11, further comprising:
program instructions to track and record, via blockchain, an amount of time a vehicle displays particular advertisements and an amount of pedestrians within the predetermined distance of the advertisement.

19. The computer system according to claim 11, wherein the displayed criteria comprise, at least in part, on real-time analytics information, including, but not limited, to a location of the vehicle, demographic information of the pedestrians within the predetermined distance of the vehicle, information obtained from mobile devices and social media accounts associated with the pedestrians, and business information of those businesses located within a predetermined distance of the vehicle.

20. The computer system according to claim 11, wherein program instructions to display is based on one or more display methods, wherein the one or more display methods comprises two-dimensional image or video, three-dimensional image or video, and holographic image or video.
